(19) United States
(12) Patent Application Publication
(10) Pub. No.: US 2017/0028983 A1
(43) Pub. Date: Feb. 2, 2017

(54) ELECTRIC VEHICLE

(71) Applicant: TOYOTA JIDOSHA KABUSHIKI KAISHA, Toyota-shi (JP)

(72) Inventor: Hideki FUKUDOME, Toyota-shi (JP)

(73) Assignee: TOYOTA JIDOSHA KABUSHIKI KAISHA, Toyota-shi (JP)

(21) Appl. No.: 15/206,405

(22) Filed: Jul. 11, 2016

(30) Foreign Application Priority Data
Jul. 30, 2015 (JP) 2015-151318

(51) Int. Cl. B60W 30/02; B60K 1/02; B60L 11/18; B60W 10/08; B60L 7/14; B60G 7/00; B60W 10/184

(52) U.S. Cl. CPC B60W 30/025; B60G 7/001; B60K 1/02; B60W 10/184; B60W 10/08; B60L 7/14; B60L 11/1803; B60G 2400/106; B60G 2800/91; B60W 2710/081; B60W 2710/182; B60W 2520/105; B60W 2520/28

(57) ABSTRACT

An electric vehicle includes electric motors imparting driving forces to the corresponding driving wheels, a brake device imparting braking forces to the driving wheels, a control unit which calculates final target braking-driving forces (Tti) of the driving wheels and controls the electric motors and the brake device so that braking-driving forces of the driving wheels conform to the corresponding final target braking-driving forces. The control unit calculates longitudinal speeds (ΔVi) of the wheels relative to a vehicle body; calculates target correction amounts (Tt2i) of the target braking-driving forces for reducing in magnitude longitudinal speeds of the driving wheels relative to the vehicle body based on the relative longitudinal speeds; and corrects the target braking-driving forces (Tt1i) with the target correction amounts (Tt2i) to calculate final target braking-driving forces (Tti) of the driving wheels.

### CROSS-REFERENCE TO RELATED APPLICATIONS

The disclosure of Japanese Patent Application No. JP 2015-151318 filed on Jul. 30, 2015 is incorporated herein by reference in its entirety.

### BACKGROUND

1. Technical Field

The present disclosure relates to an electric vehicle having electric motors imparting driving forces to corresponding driving wheels independently from each other.

2. Description of the Related Art

As an electric vehicle such as an electric automobile, an electric vehicle is well-known which has driving wheels driven by corresponding electric motors. In such an electric vehicle, under a normal travelling situation, a target braking-driving force of each wheel is calculated and each electric motor and a brake device are controlled with quick response so that an actual braking-driving force of each wheel conforms to the corresponding target braking-driving force.

Incidentally, in an electric vehicle, since, as in a vehicle which has an internal combustion engine or the like as a driving source, height of instantaneous center of each wheel is different from that of rotation axis, longitudinal excitation force acts between a wheel and a vehicle body when the wheel bounds and rebounds. Longitudinal excitation force also acts on a wheel due to turbulence caused when the wheel passes over a bump or a discontinuity of a road surface. When longitudinal excitation force acts on a wheel, it vibrates longitudinally relative to a vehicle body. The longitudinal direction is along the front-rear direction of the vehicle body. Longitudinal vibration of a wheel becomes perceptible when its frequency is in a resonance frequency range of the wheel (unsprung member). As longitudinal vibration of a wheel is transmitted to a vehicle body via a suspension and the like, occupants in a vehicle feel uneasy due to so called shaky vibration.

In an electric vehicle, reduction of longitudinal vibrations of driving wheels have been attempted by controlling braking-driving forces of the wheels.

For example, in the below-mentioned Patent Literature, there is disclosed an electric vehicle of in-wheel motor type which detects longitudinal acceleration of an unsprung member; calculates vibration suppressing force for absorbing longitudinal vibration of the unsprung member based on longitudinal acceleration of the unsprung member; and controls an electric motor so as to generate the vibration suppressing force.
[Patent Literature] Japanese Patent No. 5348328

In the electric vehicle described in the above Patent Literature, vibration suppressing force for absorbing longitudinal vibration of an unsprung member is calculated based on longitudinal acceleration of the unsprung member without considering longitudinal acceleration of a sprung member. As a result, in a situation where a vehicle accelerates and decelerates in accordance with a driver's accelerating and decelerating operation, vibration suppressing forces also serve to suppress acceleration and deceleration of the vehicle, which may hinder the driver's accelerating and decelerating demand.

### SUMMARY

It is a primary object of exemplary aspects of the present disclosure to reduce longitudinal vibrations of driving wheels while satisfying driver's accelerating and decelerating demand in an electric vehicle having electric motors imparting driving forces to corresponding driving wheels independently from each other.

According to one aspect of the present disclosure, there is provided an electric vehicle having driving wheels suspended from a vehicle body by suspensions which resiliently allows the driving wheels to displace longitudinally relative to the vehicle body, electric motors imparting driving forces to the corresponding driving wheels independently from each other, a brake device imparting braking forces to the driving wheels independently from each other, a control unit which calculates final target braking-driving forces of the driving wheels and controls the electric motors and the brake device so that braking-driving forces of the driving wheels conform to the corresponding final target braking-driving forces.

The control unit is configured to calculate longitudinal speeds of the driving wheels relative to the vehicle body; calculate target correction amounts of the target braking-driving forces for reducing in magnitude longitudinal accelerations of the driving wheels relative to the vehicle body based on the relative longitudinal speeds; and correct the target braking-driving forces with the target correction amounts to calculate final target braking-driving forces of the driving wheels.

Forces for decreasing in magnitude relative longitudinal accelerations of driving wheels relative to a vehicle body are those which have the same direction as the relative longitudinal accelerations (the opposite direction to excitation forces acting on the driving wheels) and have magnitudes that are proportion to longitudinal speeds of the driving wheels relative to the vehicle body. According to the above-mentioned configuration, longitudinal speeds of the driving wheels relative to the vehicle body are calculated; target correction amounts of the target braking-driving forces for reducing in magnitude longitudinal accelerations of the driving wheels relative to the vehicle body are calculated based on the relative longitudinal speeds; and the target braking-driving forces are corrected with the target correction amounts to calculate final target braking-driving forces of the driving wheels. Consequently, braking-driving forces of the driving wheels can be controlled so as to generate damping forces which at least partially oppose vibration excitation forces of the driving wheels acting on the vehicle body.

Since target correction amounts of the target braking-driving forces for reducing in magnitude longitudinal accelerations of the driving wheels relative to the vehicle body are calculated based on the relative longitudinal speeds, the amounts do not interfere with the vehicle body and the driving wheels displacing with acceleration and deceleration in accordance with braking-driving demand of the driver. Consequently, longitudinal vibrations of the driving wheels can be reduced while satisfying braking-driving demand of the driver.

According to another aspect of the present disclosure, the control unit is configured to limit target correction amounts in magnitude by limiting the magnitudes of the relative longitudinal speeds to a reference value when the magnitudes of the relative longitudinal speeds are larger than the reference value.

According to the above-mentioned configuration, target correction amounts are limited in magnitude by limiting the magnitudes of the relative longitudinal speeds to a reference value when the magnitudes of the relative longitudinal speeds are larger than the reference value. As such, in a situation where large longitudinal forces act on driving wheels and relative speeds increase in magnitude due to turbulence caused when, for example, the wheels pass over a bump or a discontinuity of a road surface, longitudinal compliance can be prevented from decreasing due to high damping forces being generated. Consequently, according to the configuration, longitudinal vibrations of the driving wheels can be reduced while preventing harshness from being worsened.

According to another aspect of the present disclosure, the control unit is configured to process relative longitudinal speeds by a low-pass filter and to calculate target correction amounts based on the low-pass filtered relative longitudinal speeds.

As will be described in detail later, in a range where longitudinal vibrations of the driving wheels are high in frequency, if target braking-driving forces are corrected with target correction amounts for reducing in magnitude longitudinal speeds of the driving wheels relative to the vehicle body, longitudinal vibration of the driving wheels is caused to worsen. According to the above-mentioned configuration, relative longitudinal speeds are processed by a low-pass filter and target correction amounts are calculated based on the low-pass filtered relative longitudinal speeds. As such, in a situation where longitudinal vibrations of the driving wheels are high in frequency and relative longitudinal speeds are accordingly high in frequency, target correction amounts can be reduced. Consequently, it is possible to suppress longitudinal vibrations of the driving wheels from worsening due to the cause that target braking-driving forces are corrected with target correction amounts in the range where longitudinal vibrations of the driving wheels are high in frequency.

According to another aspect of the present disclosure, the control unit is configured to frequency analyze relative longitudinal speeds and limit target correction amounts in magnitude when principal frequencies of the relative longitudinal speeds are not within a preset specific frequency range.

As will be described in detail later, in a range where longitudinal speeds of the driving wheels are low in frequency, damping effect cannot be expected even if target braking-driving forces are corrected with target correction amounts for reducing in magnitude longitudinal speeds of the driving wheels relative to the vehicle body. As already described above, in a range where longitudinal vibrations of the driving wheels are high in frequency, if target braking-driving forces are corrected with target correction amounts for reducing in magnitude longitudinal speeds of the driving wheels relative to the vehicle body, longitudinal vibration of the driving wheels is caused to worsen. Accordingly, in a situation where principal frequencies of relative longitudinal speeds are not within the specific frequency range, it is preferable to limit correction of target braking-driving forces with target correction amounts.

According to the above-mentioned configuration, relative longitudinal speeds are frequency analyzed and when principal frequencies of the relative longitudinal speeds are not within the specific frequency range, target correction amounts are limited in magnitude. Thus, according to the configuration, possibilities can be reduced that target braking-driving forces are unnecessarily corrected with target correction amounts and that longitudinal vibrations of the driving wheels are caused to worsen by correction of target braking-driving forces with target correction amounts.

According to another aspect of the present disclosure, the electric vehicle has devices which detect longitudinal accelerations of the vehicle body at positions corresponding to the driving wheels and devices which detect longitudinal accelerations of the driving wheels; and the control unit is configured to calculate relative longitudinal speeds by integrating differences between the longitudinal accelerations of the vehicle body and the longitudinal accelerations of the driving wheels.

According to the above-mentioned configuration, relative longitudinal speeds are calculated by integrating differences between the longitudinal accelerations of the vehicle body and the longitudinal accelerations of the driving wheels. Thus, according to the configuration, longitudinal speeds of the driving wheels relative to the vehicle body can be calculated.

According to another aspect of the present disclosure, the electric vehicle has devices which detect longitudinal speeds of the vehicle body at positions corresponding to the driving wheels and devices which detect longitudinal speeds of the driving wheels; and the control unit is configured to calculate relative longitudinal speeds by calculating differences between the longitudinal speeds of the vehicle body and the longitudinal speeds of the driving wheels.

According to the above-mentioned configuration, longitudinal speeds of the vehicle body at positions corresponding to the driving wheels are detected and longitudinal speeds of the driving wheels are detected. Differences between the longitudinal speeds of the vehicle body and the longitudinal speeds of the driving wheels are calculated as relative longitudinal speeds. Thus, according to the configuration, longitudinal speeds of the driving wheels relative to the vehicle body can as well be calculated.

Next, before describing embodiments, a principle of the present disclosure which is adopted in the embodiments will be explained so as to make it easier to understand the present disclosure.

As illustrated in FIG. 8 showing a vehicle model for a rear wheel, relative longitudinal motion of a sprung member (vehicle body) 102 and an unsprung member (wheel) 104 of a vehicle 101 is considered.

When the sprung member 102 and the unsprung member 104 relatively move in a longitudinal direction of the vehicle, a longitudinal component of elastic force of a suspension spring and a longitudinal component of elastic force generated by deformation of elastic members such as a rubber bushing act between the sprung member 102 and the unsprung member 104. Further, when the sprung member 102 and the unsprung member 104 relatively move in a longitudinal direction of the vehicle, a longitudinal component of damping force of a shock absorber inclined longitudinally and a longitudinal component of damping force generated by internal friction caused by deformation of elastic members such as a rubber bushing act as well between the sprung member 102 and the unsprung member 104.

In a general conventional vehicle, a virtual suspension spring 106 and a virtual shock absorber 108 may be considered to exist between the sprung member 102 and the unsprung member 104. A spring constant of the virtual suspension spring 106 and a damping coefficient of the virtual shock absorber 108 are constant. As such, if a damping coefficient of the virtual shock absorber 108 is set high so as to effectively damp relative vibration of the sprung member 102 and the unsprung member 104, ride comfort of the vehicle is deteriorated due to harshness. In contrast, if a damping coefficient of the virtual shock absorber 108 is set low so as to enhance ride comfort of the vehicle, relative vibration of the sprung member 102 and the unsprung member 104 cannot be effectively damped.

In view of the above, as illustrated in FIG. 9, a configuration is considered in which a virtual force generation device 110 is also arranged between the sprung member 102 and the unsprung member 104 and the device is caused to generate force Fᵤᵥ as necessary which acts as damping force in the longitudinal direction. The following Formulae (1) and (2) hold as motion equations of the sprung member 102 and the unsprung member 104, respectively, with respect to the longitudinal direction.

m_{b}\ddot{x}_{b}=F_{cv}+Fₖᵥ+Fᵤᵥ (1)

mᵤ\ddot{x}ᵤ=Fₜᵥ−F_{cv}−Fₖᵥ−Fᵤᵥ (2)

In the above Formulae, m_{b} represents a mass of the portion of the sprung member 102 corresponding to the unsprung member 104, and mᵤ represents a mass of the unsprung member 104. X_{b}(\ddot{}) and Xᵤ(\ddot{}) represent second-order differential values of displacements X_{b} and Xᵤ of the sprung member 102 and the unsprung member 104, respectively, i.e., longitudinal acceleration of the sprung member 102 and the unsprung member 104, respectively. F_{cv} represents damping force of the virtual shock absorber 108; Fₖᵥ represents elastic force of the virtual suspension spring 106; and Fₜᵥ represents driving force of the unsprung member 104.

Damping force F_{cv} of the virtual shock absorber 108 is represented by the following Formula (3); elastic force Fₖᵥ of the virtual suspension spring 106 is represented by the following Formula (4); and force Fᵤᵥ generated by the virtual force generation device 110 is represented by the following Formula (5).

F_{cv}=−cₛ(\dot{x}_{b}−\dot{x}ᵤ) (3)

Fₖᵥ=−kₛ(x_{b}−xᵤ) (4)

Fᵤᵥ=−cₕ(\dot{x}_{b}−\dot{x}ᵤ) (5)

In the above Formulae, X_{b}(\dot{}) and Xᵤ(\dot{}) represent differential values of displacements X_{b} and Xᵤ, i.e., longitudinal speeds of the sprung member 102 and the unsprung member 104, respectively. Cₛ represents an equivalent damping coefficient of the virtual shock absorber 108; kₛ represents an equivalent spring constant of the virtual suspension spring 106; and Cₕ represents a coefficient of the virtual force generation device 110 which corresponds to damping coefficient.

Driving force Fₜᵥ of the unsprung member 104 is represented by the following Formula (6).

$${F}_{tv} = D ( \frac{{\dot{x}}_{u} - {r}_{t} {ω}_{t}}{{\dot{x}}_{u}} ) + \frac{{F}_{z}}{{\dot{x}}_{u}} {\dot{z}}_{0} \qquad ( 6 )$$

In the above Formula, D represents driving stiffness; rₜ represents a radius of the wheel of the unsprung member 104; and ωₜ represents angular velocity of the wheel. F_{z} represents vertical force of the unsprung member 104 and z₀ represents vertical displacement of a road surface 112.

Transfer functions from driving force Fₜᵥ of the unsprung member 104 to longitudinal displacements X_{b} and Xᵤ of the sprung member 102 and the unsprung member 104 are represented by the following Formulae (7) and (8), respectively, where s represents Laplacian operator.

$$\begin{matrix}{x}_{b} = \frac{1}{{s}^{2}} \cdot \frac{( ( {c}_{s} + {c}_{h} ) s + {k}_{s} ) {F}_{tv}}{( {m}_{u} {m}_{b} {s}^{2} + ( {m}_{u} + {m}_{b} ) ( {c}_{s} + {c}_{h} ) s + ( {m}_{u} + {m}_{b} ) {k}_{s} )} & ( 7 ) \\ {x}_{u} = \frac{1}{{s}^{2}} \cdot \frac{( {m}_{b} {s}^{2} + ( {c}_{s} + {c}_{h} ) s + {k}_{s} ) {F}_{tv}}{( {m}_{u} {m}_{b} {s}^{2} + ( {m}_{u} + {m}_{b} ) ( {c}_{s} + {c}_{h} ) s + ( {m}_{u} + {m}_{b} ) {k}_{s} )} & ( 8 )\end{matrix}$$

Frequency responses of second-order differential values of displacements of X_{b} and Xᵤ, i.e., longitudinal acceleration X_{b}(\ddot{}) and Xᵤ(\ddot{}) to driving force Fₜᵥ have properties shown in solid lines in FIGS. 10 and 11, respectively. In FIGS. 10 and 11, broken lines show frequency response of second-order differential values of displacements of X_{b} and Xᵤ to driving force Fₜᵥ for a conventional general vehicle.

From comparison of solid and broken lines in FIG. 10, it is understood that provision of the virtual force generation device 110 can decrease a ratio X_{b}(\ddot{})/Fₜᵥ of longitudinal acceleration of the sprung member 102 to driving force Fₜᵥ at 10 Hz and in the vicinity, for example, a frequency range f_{c1}-f_{c2}. In a similar manner, from comparison of solid and broken lines in FIG. 11, it is understood that provision of the virtual force generation device 110 can decrease a ratio Xᵤ(\ddot{})/Fₜᵥ of longitudinal acceleration of the unsprung member 104 to driving force Fₜᵥ at 10 Hz and in the vicinity.

It is to be noted from FIG. 10 that since the effect resulting from force Fᵤᵥ being generated by the virtual force generation device 110 cannot be expected in a range where frequency is below f_{c1}, the virtual force generation device 110 may not generate force Fᵤᵥ. It is also to be noted that if the virtual force generation device 110 generates force Fᵤᵥ in a range where frequency is over f_{c2}, a ratio X_{b}(\ddot{})/Fₜᵥ of longitudinal acceleration of the sprung member 102 to driving force Fₜᵥ may be caused to worsen, and accordingly, the virtual force generation device 110 preferably does not generate force Fᵤᵥ.

### BRIEF DESCRIPTION OF THE DRAWINGS

FIG. 1 is a schematic view for illustrating an electric vehicle according to a first embodiment of the present disclosure applied to a four-wheel drive vehicle of in-wheel motor type.

FIG. 2 is a flowchart for illustrating a routine for controlling braking-driving forces of wheels in the first embodiment.

FIG. 3 is a flowchart for illustrating a routine for controlling braking-driving forces of wheels in a second embodiment which is applied to a four-wheel drive vehicle of in-wheel motor type.

FIG. 4 is a flowchart for illustrating a routine for controlling braking-driving forces of wheels in a third embodiment which is applied to a four-wheel drive vehicle of in-wheel motor type.

FIG. 5 is a schematic view for illustrating an electric vehicle according to a modified embodiment of the present disclosure applied to a four-wheel drive vehicle of in-wheel motor type.

FIG. 6 is a map for illustrating a relationship between vehicle speed V and a reference value ΔV0.

FIG. 7 is a map for illustrating a relationship between a principal frequency fm of longitudinal speeds ΔVi of wheels relative to a vehicle body and a coefficient Cv.

FIG. 8 is a view of a vehicle model for illustrating longitudinal relative motion of sprung and unsprung members in a conventional general vehicle.

FIG. 9 is a view of a vehicle model for illustrating longitudinal relative motion of sprung and unsprung members in a vehicle in which braking-driving forces of wheels are controlled in accordance with the present disclosure.

FIG. 10 is a graph for illustrating frequency response of a transfer function from braking-driving force Ftv of a wheel to an sprung member displacement x_{bdd} in a conventional general vehicle (broken line) and a vehicle in which braking-driving forces of wheels are controlled in accordance with the present disclosure (solid line.)

FIG. 11 is a graph for illustrating frequency response of a transfer function from braking-driving force Ftv of a wheel to an unsprung member displacement c_{udd} in a conventional general vehicle (broken line) and a vehicle in which braking-driving forces of wheels are controlled in accordance with the present disclosure (solid line.)

### DETAILED DESCRIPTION

Now, with reference to the accompanying drawings, some preferred embodiments of the present disclosure are described in detail.

### First Embodiment

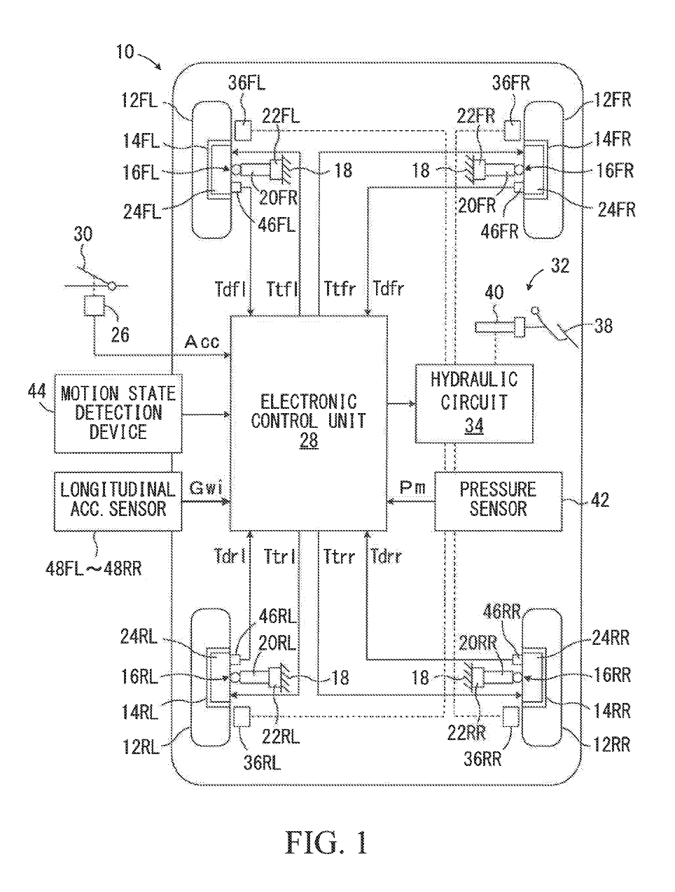

FIG. 1 is a schematic view for illustrating an electric vehicle 10 according to a first embodiment of the present disclosure applied to a four-wheel drive vehicle of in-wheel motor type. The electric vehicle 10 has left and right front wheels 12FL and 12FR which are steered wheels and left and right rear wheels 12RL and 12RR which are non-steered wheels. The front wheels 12FL and 12FR are supported by wheel support members 14FL and 14FR, respectively, so as to rotate about rotation axes of the wheels. In a similar manner, the rear wheels 12RL and 12RR are supported by wheel support members 14RL and 14RR, respectively, so as to rotate about rotation axes of the wheels. The front wheels 12FL and 12FR are suspended from a vehicle body 18 by front wheel suspensions 16FL and 16FR and the rear wheels 12RL and 12RR are suspended from the vehicle body 18 by rear wheel suspensions 16RL and 16RR.

The front wheel suspensions 16FL and 16FR include suspension aims 20FL and 20FR, respectively. The suspension arms 20FL and 20FR are swingably coupled at their inner ends to the vehicle body 18 by rubber bushing devices 22FL and 22FR, respectively, and are swingably coupled at their outer ends to the wheel support members 14FL and 14FR, respectively, by joints such as ball joints. The front wheel suspensions 16FL and 16FR resiliently allow the front wheels 12FL and 12FR to displace longitudinally relative to the vehicle body 18. Although only one each of the suspension arms 20FL, 20FR, the rubber bushing devices 22FL, 22FR and joints are shown in FIG. 1, these members may be provided in plural.

In a similar manner, the rear wheel suspensions 16RL and 16RR include suspension arms 20RL and 20RR, respectively. The suspension arms 20RL and 20RR are swingably coupled at their inner ends to the vehicle body 18 by rubber bushing devices 22RL and 22RR, respectively, and are swingably coupled at their outer ends to the wheel support members 14RL and 14RR, respectively, by joints such as ball joints. The rear wheel suspensions 16RL and 16RR resiliently allow the rear wheels 12RL and 12RR to displace longitudinally relative to the vehicle body 18. Although only one each of the suspension arms 20RL, 20RR, the rubber bushing devices 22RL, 22RR and joints are shown in FIG. 1, these members may be provided in plural.

Although not shown in figures, as is well known in the art, shock absorbers and suspension springs are arranged between the wheel support members 14FL-14RR or the suspension arms 20FL-20RR and portions of the vehicle body 18 located above them. The shock absorbers elongate inclined longitudinally and laterally and damp vibrations of the vehicle body 18 relative to the wheels 12FL-12RR. The suspension springs allow the wheels 12FL-12RR to displace relative to the vehicle body 18 and attenuate transmission of shock from the wheels 12FL-12RR to the vehicle body 18.

The front wheels 12FL and 12FR are driven by driving forces which are imparted independently from each other from in-wheel motors 24FL and 24FR incorporated in the wheel support members 14FL and 14FR, respectively, through reduction devices, not shown in FIG. 1. Similarly, the rear wheels 12RL and 12RR are driven by driving forces which are imparted independently from each other from in-wheel motors 24RL and 24RR incorporated in the wheel support members 14RL and 14RR, respectively, through reduction devices, not shown in FIG. 1.

The in-wheel motors 24FL-24RR may be any electric motors that can be controlled in driving torque and rotation speed such as brushless three-phase AC motors. While each of the in-wheel motors 24FL-24RR preferably functions as a regeneration generator during braking and generates regenerative braking torque, it may not perform regenerative braking.

As described in detail hereinafter, driving forces of the in-wheel motors 24FL-24RR are controlled by a driving force control section in a controller, such as an electronic control unit 28, on the basis of accelerator opening Acc detected by an accelerator opening sensor 26. Accelerator opening Acc indicates depressed amount of an accelerator pedal 30, i.e., driving operation amount of a driver. Regenerative braking forces of the in-wheel motors 24FL-24RR are controlled by a braking force control section in the electronic control unit 28 through the driving force control section.

Although not shown in FIG. 1, during normal travelling of the vehicle 10, electricity charged in a battery is supplied to the in-wheel motors 24FL-24RR through a drive circuit in the driving force control section. During braking of the vehicle 10, electricity generated by regenerative braking executed by the in-wheel motors 24FL-24RR is charged into the battery through the drive circuit.

The front wheels 12FL, 12FR and the rear wheels 12RL, 12RR are imparted with friction braking forces independently from each other by a friction brake device 32. Friction braking forces of the front wheels 12FL, 12FR and the rear wheels 12RL, 12RR are controlled by means of a hydraulic circuit 34 in the friction brake device 32 controlling pressures in wheel cylinders 36FL, 36FR, 36RL and 36RR, respectively, i.e., braking pressures. Although not shown in the figures, the hydraulic circuit 34 includes a reservoir, an oil pump and various valve devices and the like.

Pressures in the wheel cylinders 36FL-36RR are usually controlled in accordance with pressure in a master cylinder 40 driven by the driver's operation of depressing a brake pedal 38. The pressure is hereinafter referred to as master cylinder pressure. Master cylinder pressure indicates pressing force on the brake pedal 38, i.e., braking operation amount of the driver. Pressure in each wheel cylinder is also individually controlled as necessary irrespective of operation amount of depressing the brake pedal 38 by means of the oil pump and various valve devices being controlled by the braking force control section in the electronic control unit 28.

While in the illustrated embodiment, the friction brake device 32 is a hydraulic friction brake device, it may be an electro-magnetic friction brake device so long as it can impart friction braking force to each of the wheels independently from one another.

Although not shown in FIG. 1, the electronic control unit 28 includes, in addition to the driving force control section and the braking force control section, an integral control section which controls the sections. The three control sections give and receive signals to and from each other as necessary. The integral control part fundamentally controls braking-driving forces of the four wheels by controlling the in-wheel motors 24FL-24RR and the friction brake device 32 through the driving force control section and the braking force control section so that vehicle braking-driving force conforms to braking-driving force demanded by the driver.

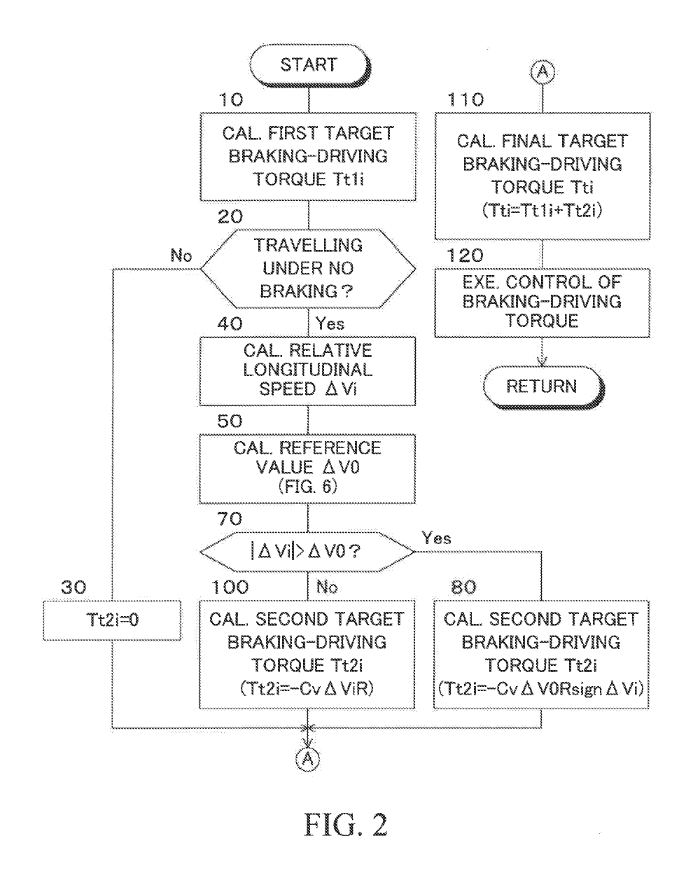

Although not shown in detail in FIG. 1, each control section in the electronic control unit 28 has a microcomputer and a drive circuit. Each microcomputer may have a general configuration including CPU, ROM, RAM and input/output ports connected with one another via a bidirectional common bus. An exemplary ROM stores a control program corresponding to a flowchart shown in FIG. 2 and an exemplary CPU executes the program.

The electronic control unit 28 is supplied with a signal indicative of a master cylinder pressure Pm from a pressure sensor 42 in addition to a signal indicative of an accelerator opening Acc detected by the accelerator opening sensor 26. The electronic control unit 28 is additionally supplied with signals indicative of parameters with reference to motion state of the vehicle 10 such as vehicle speed, yaw rate, longitudinal acceleration and lateral acceleration of the vehicle 10 from motion state detection device 44. Additional sensors may be provided including, for example, speed sensors configured to detect longitudinal speeds of the vehicle body at positions corresponding to the driving wheels and devices configured to detect longitudinal speeds of the driving wheels.

The in-wheel motors 24FL-24RR have therein torque sensors 46FL-46RR, respectively, which detect driving torques Tdi (i=fl, fr, rl and rr) of the corresponding in-wheel motors. The wheel support members 14FL-14RR have longitudinal acceleration sensors 48FL-48RR, respectively, which detect longitudinal accelerations Gwi (i=fl, fr, rl and rr) of the corresponding wheels 12FL-12RR. The electronic control unit 28 receives signals indicative of driving torques Tdi from the torque sensors 46FL-46RR and signals indicative of longitudinal accelerations Gwi from the longitudinal acceleration sensors 48FL-48RR.

The electronic control unit 28 calculates first target braking-driving torques Tt1i (i=fl, fr, rl and rr) of the wheels based on braking-driving operation amount of the driver according to a flowchart shown in FIG. 2 on the basis of accelerator opening Acc and master cylinder pressure Pm. The electronic control unit 28 also calculates second target braking-driving torques Tt2i (i=fl, fr, rl and rr) of the wheels for reducing longitudinal vibrations of the wheels 12FL-12RR relative to the vehicle body 18.

In particular, the electronic control unit 28 calculates differences ΔGi (i=fl, fr, rl and rr) between longitudinal accelerations Gbi (i=fl, fr, rl and rr) of the vehicle body 18 and longitudinal accelerations Gwi of the wheels in accordance with the following Formula (9) in which Gbi represent longitudinal accelerations of the vehicle body 18 at positions corresponding to the wheels 12FL-12RR. Calculation of longitudinal accelerations Gbi of the vehicle body 18 will be described later. The electronic control unit 28 also calculates longitudinal speeds ΔVi (i=fl, fr, rl and rr) of the wheels relative to the vehicle body 18 by integrating the differences ΔGi. The relative longitudinal speeds ΔVi are differences between longitudinal speeds Vbi of the vehicle body 18 at positions corresponding to the wheels 12FL-12RR and longitudinal speeds of the corresponding wheels.

ΔGi=Gbi−Gwi (9)

When the absolute value of the relative longitudinal speeds ΔVi are not larger than a reference value ΔV0 (a positive value), the electronic control unit 28 calculates second target braking-driving torques Tt2i in accordance with the following Formula (10) in which Cv represents a positive constant coefficient and R represents a rotation radius of the wheels. In contrast, when the absolute value of the relative longitudinal speeds ΔVi are larger than the reference value ΔV0, the electronic control unit 28 calculates second target braking-driving torques Tt2i in accordance with the following Formula (11) in which sign(ΔVi) represents the sign of relative longitudinal speeds ΔVi. Second target braking-driving torques Tt2i are target correction amounts for reducing in magnitude relative longitudinal accelerations of the wheels relative to the vehicle body 18. Note that as described later, the reference value ΔV0 is varied in accordance with vehicle speed V.

Tt2i=−CvΔViR (10)

Tt2i=−CvΔViRsign(ΔVi) (11)

The electronic control unit 28 calculates final target braking-driving torques Tti (i=fl, fr, rl and rr) which are totals of the first target braking-driving torques Tt1i and the second target braking-driving torques Tt2i. Further, the electronic control unit 28 controls outputs of the in-wheel motors 24FL-24RR and outputs of the friction brake device 32 so that actual braking-driving torques of the wheels conform to the corresponding final target braking-driving torques Tti. According to the final target braking-driving torques Tti, the electronic control unit 28 may control an electric motor of the in-wheel motors 24FL-24RR or the friction brake device 32. As used above and herewith, “or” is inclusive or, meaning that the electronic control unit 28 may control any one of: an electric motor of the in-wheel motors 24FL-24RR, the friction brake device 32, and both the electric motor and the friction brake device 32.

It is to be noted that first target braking-driving torques Tt1i, second target braking-driving torques Tt2i and final target braking-driving torques Tti assume positive values when they are driving torques and assume negative values when they are braking torques. In particular, when final target braking-driving torques Tti are driving torques, actual driving torques of the wheels are controlled so as to conform to final target braking-driving torques Tti by controlling mainly driving torques of the in-wheel motors 24FL-24RR (including regenerative braking.) In contrast, when final target braking-driving torques Tti are braking torques, actual braking torques of the wheels are controlled so as to conform to final target braking-driving torques Tti by controlling mainly braking torques generated by the friction brake device 32.

Next, referring to the flowchart shown in FIG. 2, a control routine of braking-driving forces of the wheels in the first embodiment will be explained. It is to be noted that the control in accordance with the flowchart shown in FIG. 2 is repeatedly executed at predetermined intervals in the order of, for example, front left, front right, rear left and rear right wheels when an ignition switch not shown in the figures is turned on. In the following explanations, the control of braking-driving forces of the wheels executed in accordance with the flowchart shown in FIG. 2 is simply referred to as “the control.”

First, in step 10, first target braking-driving torque Tt1i based on braking-driving operation amount of the driver is calculated on the basis of accelerator opening Acc and preset front-rear wheel distribution ratio of driving torque. For example, it is assumed that Ttall represents target driving torque of the entire vehicle based on accelerator opening Acc and Rf represents a front wheel distribution ratio of driving force which is larger than 0 and smaller than 1. Target driving torques Ttfl and Ttfr of the left and right front wheels, respectively, are calculated to be TtallRf/2 and Target driving torques Ttrl and Ttrr of the left and right rear wheels, respectively, are calculated to be Ttall(1−Rf)/2. Note that as accelerator opening Acc is a positive value or 0, first target braking-driving torque Tt1i is calculated to be driving torques (positive values or 0.)

In step 20, a decision is made as to whether or not the vehicle is travelling under no braking (travelling without braking) on the basis of a signal sent from vehicle speed sensor, not shown, and a signal sent from the pressure sensor 42. When an affirmative decision is made, the control proceeds to step 40, while when a negative decision is made, in step 30, second target braking-driving torque Tt2i is set to 0 and then the control proceeds to step 110. Note that the reason why a decision is made as to whether or not braking is not conducted is that it would be preferable to give priority to satisfaction of braking demand of the driver rather than damping of the wheels.

In step 40, longitudinal acceleration Gbi of the vehicle body 18 at positions corresponding to the wheels are calculated on the basis of longitudinal acceleration and yaw rate of the vehicle 10 at a gravity center position detected by the motion state detection device 44 and specification of the vehicle. In addition, differences ΔGi between longitudinal accelerations Gbi of the vehicle body 18 and longitudinal accelerations Gwi of the wheels are calculated in accordance with the above-mentioned Formula (9), and longitudinal speeds ΔVi of the wheels relative to the vehicle body 18 are calculated by integrating the differences ΔGi. Note that step 40 may function with a device which cooperates with the motion state detection device 44 to detect longitudinal accelerations Gbi of the vehicle body 18 at positions corresponding to the wheels.

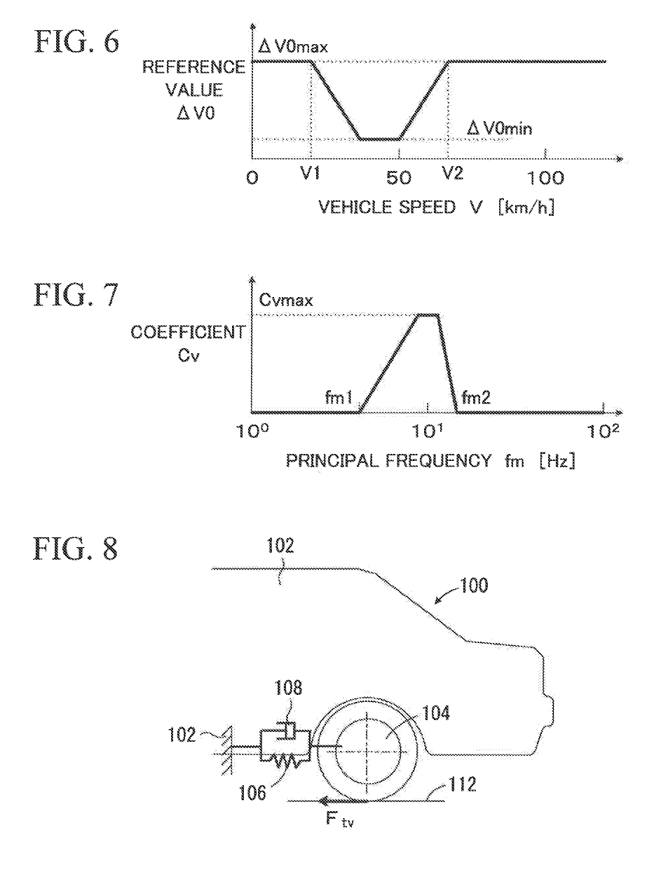

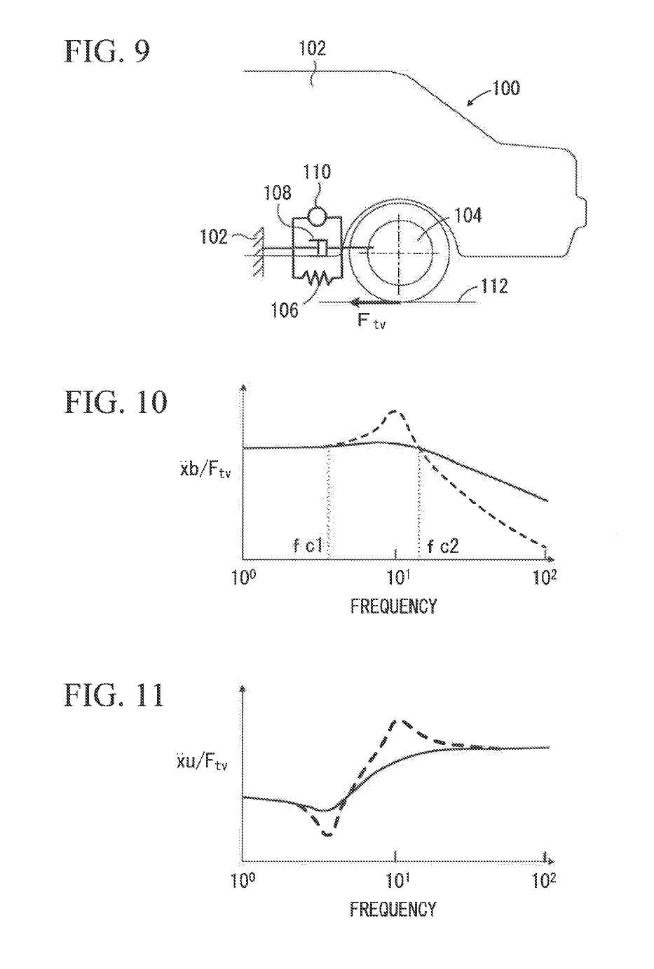

In step 50, a reference value ΔV0 is calculated by referring to a map shown in FIG. 6 based on vehicle speed V detected by the motion state detection device 44. As illustrated in FIG. 6, a reference value ΔV0 is variably set in accordance with vehicle speed V so that it assumes a small value (it may be 0) when vehicle speed V is 40 km/h or a value in the vicinity (specific vehicle speed range). Note that the reason why reference value ΔV0 is set so as to assume a small value when vehicle speed V is 40 km/h or in the vicinity is that a phenomena is considered in which harshness generally becomes perceptible when vehicle speed V is 40 km/h or in the vicinity. The specific vehicle speed range varies in accordance with specification of the vehicle and may be set to a predetermined specific vehicle speed range which is based on characteristics of the vehicle 101, comprising a lower limit speed V1 and upper limit speed V2.

After step 50 is completed, the control proceeds to step 70. In step 70, a decision is made as to whether or not absolute values of relative longitudinal speeds ΔVi are larger than the reference value ΔV0, i.e., as to whether or not second target braking-driving torques Tt2i become extremely large in magnitude. When a negative decision is made, the control proceeds to step 100, while when an affirmative decision is made, the control proceeds to step 80.

In step 80, second target braking-driving torques Tt2i are calculated in accordance with the above-mentioned Formula (11), and in step 100, second target braking-driving torques Tt2i are calculated in accordance with the above-mentioned Formula (10).

After step 80 or 100 is completed, the control proceeds to step 110. In step 110, final target braking-driving torques Tti are calculated to be a total Tt1i+Tt2i of the first target braking-driving torque Tt1i and the second target braking-driving torque Tt2i.

In step 120, the in-wheel motors 24FL-24RR and the friction brake device 32 are controlled so that actual braking-driving torques of the wheels conform to the corresponding final target braking-driving torques Tti.

As is understood from the above, in step 10, first target braking-driving torques Tt1i which correspond to target braking-driving forces of the wheels based on braking-driving operation amount of the driver are calculated, and in step 40, longitudinal speeds ΔVi of the wheels relative to the vehicle body 18 are calculated. In step 50, reference value ΔV0 is calculated, and in step 70, when a decision is made that absolute value of relative longitudinal speeds ΔVi is not larger than the reference value ΔV0, in step 100, second target braking-driving torques Tt2i are calculated in accordance with the above-mentioned Formula (10). Further, in step 110, final target braking-driving torques Tti are calculated to be a total Tt1i+Tt2i of the first target braking-driving torques Tt1i and the second target braking-driving torques Tt2i, and in step 120, actual braking-driving torques of the wheels are controlled so as to conform to the corresponding final target braking-driving torques Tti.

Forces for reducing in magnitude longitudinal speeds of the wheels 12FL-12RR relative to the vehicle body 18 are those which oppose vibration excitation forces acting on the wheels 12FL-12RR. Second target braking-driving torques Tt2i are torques for generating forces which oppose the vibration excitation forces and are calculated as target correction amounts for correcting first target braking-driving torques Tt1i which correspond to target braking-driving forces. Accordingly, final target braking-driving torques Tti are calculated as values in which first target braking-driving torques Tt1i are corrected with second target braking-driving torques Tt2i so that forces which oppose the vibration excitation forces are generated. Therefore, it is possible to generate damping forces which at least partially oppose the vibration excitation forces acting on the wheels to reduce longitudinal vibrations of the wheels.

Second target braking-driving torques Tt2i which serve as target correction amounts are calculated on the basis of relative longitudinal speeds ΔVi. As such, second target braking-driving torques Tt2i do not interfere with the vehicle body 18 and the wheels 12FL-12RR displacing in accordance with braking-driving demand of the driver. Consequently, longitudinal vibrations of the wheels can be reduced while satisfying braking-driving demand of the driver.

### Second Embodiment

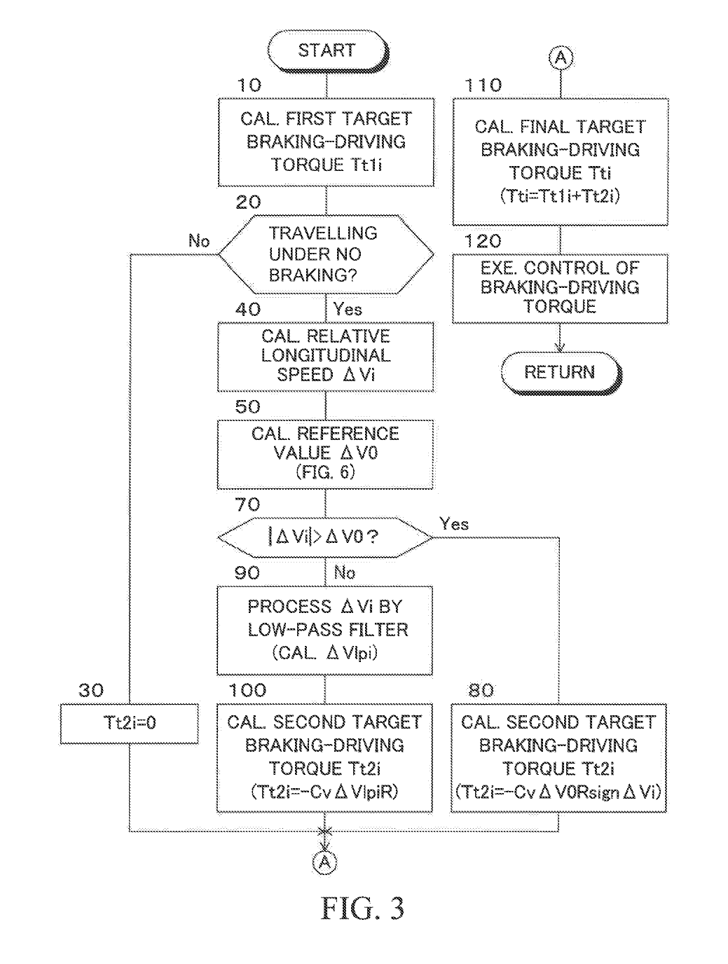

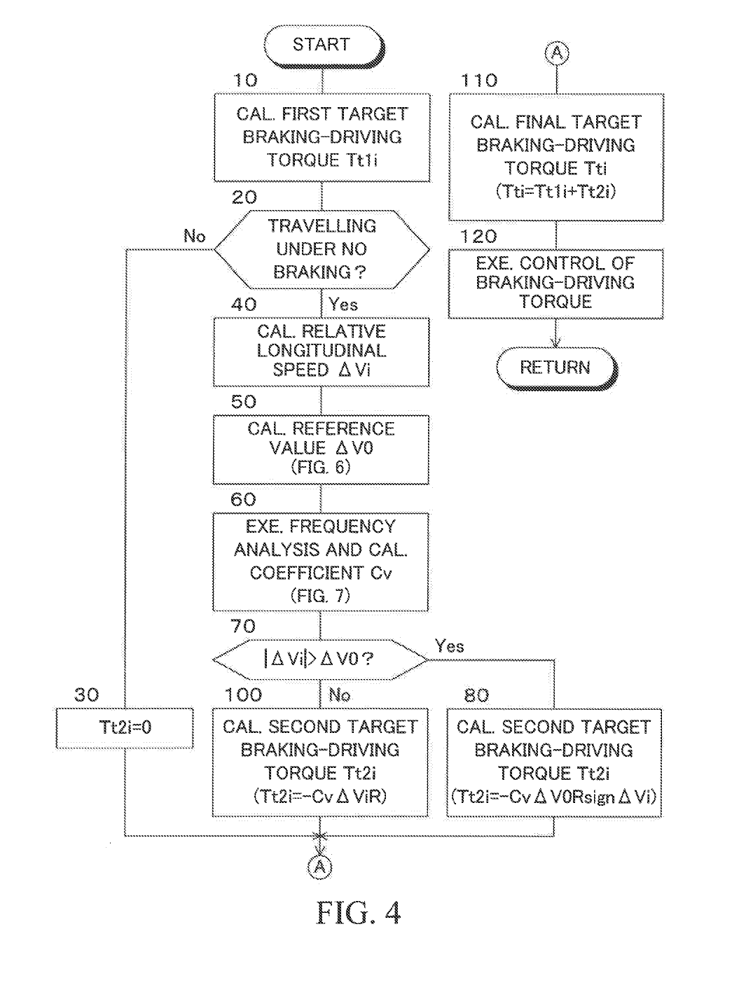

FIG. 3 is a flowchart for illustrating a routine for controlling braking-driving forces of wheels in an electric vehicle 10 according to the second embodiment which is applied to a four-wheel drive vehicle of in-wheel motor type. Note that, in FIG. 3, the same steps as those illustrated in FIG. 2 are denoted by the same step numerals as those of FIG. 2. The same goes for FIG. 4, referred to later.

As is understood from comparing FIG. 3 with FIG. 2, in the second embodiment, when a negative decision is made in step 70, step 90 is conducted. After step 90 is completed, the control proceeds to step 100. The steps other than these steps are conducted in the same manner as in the first embodiment.

In step 90, longitudinal speeds ΔVi of the wheels relative to the vehicle body 18 calculated in step 40 are processed by a low-pass filter to calculate low-pass filtered relative longitudinal speeds ΔVlpi (i=fl, fr, rl and rr.) Note that a cut-off frequency of the low-pass filter is set to a value corresponding to f_{c2} in FIG. 10.

In step 100, second target braking-driving torques Tt2i are calculated in accordance with the following Formula (12), which corresponds to the above-mentioned Formula (10), utilizing low-pass filtered relative longitudinal speeds ΔVlpi calculated in step 70.

Tt2i=−CvΔVlpiR (12)

As is understood from the explanation given above referring to FIG. 10, in a range where frequencies of relative longitudinal speeds ΔVi are high, if first target braking-driving torques Tt1i are corrected with second target braking-driving torques Tt2i, longitudinal vibrations of the vehicle body 18 are caused to worsen. Accordingly, in a range where frequencies of relative longitudinal speeds ΔVi are high, it is preferable to reduce second target braking-driving torques Tt2i in magnitude.

According to the second embodiment, in step 90, relative longitudinal speeds ΔVi of the wheels are processed by a low-pass filter, and in step 100, second target braking-driving torques Tt2i are calculated utilizing low-pass filtered relative longitudinal speeds ΔVlpi. As such, in a range where frequencies of relative longitudinal speeds ΔVi are high, second target braking-driving torques Tt2i can be reduced in magnitude. Consequently, it is possible to suppress longitudinal vibrations of the vehicle body 18 from worsening which is due to the cause that first target braking-driving torques Tt1i are corrected with second target braking-driving torques Tt2i in a range where frequencies of relative longitudinal speeds ΔVi are high.

### Third Embodiment

FIG. 4 is a flowchart for illustrating a routine for controlling braking-driving forces of wheels in an electric vehicle 10 according to the third embodiment which is applied to a four-wheel drive vehicle of in-wheel motor type.

As is understood from comparing FIG. 4 with FIG. 2, in the third embodiment, after step 50 is completed, the control proceeds to step 60 and after step 60 is completed, the control proceeds to step 70. The steps other than step 60 are conducted in the same manner as in the first embodiment.

In step 60, longitudinal speeds ΔVi of the wheels relative to the vehicle body 18 calculated in step 40 are frequency analyzed to derive principal frequencies fm of longitudinal speeds ΔVi. Further, coefficient Cv is calculated by referring to a map shown in FIG. 7 based on each of principal frequencies fm. As shown in FIG. 7, coefficient Cv is calculated to be a positive value Cvmax when principal frequencies fm are values within a specific frequency range, i.e., 10 Hz or a value in the vicinity, and to decrease as principal frequencies fm leave from the specific frequency range. Furthermore, coefficient Cv is calculated to be 0 when principal frequencies fm are not larger than fm1 or is not smaller than fm2. The values of fm1 and fm2 are substantially the same as fc1 and fc2 shown in FIG. 10.

It is to be noted that considering the following points led to the calculation of coefficient Cv utilizing the map shown in FIG. 7. The damping effect of longitudinal vibrations of wheels by controlling braking-driving forces of the wheels executed in accordance with the present disclosure is high in the range where frequencies of relative longitudinal speeds ΔVi are from fc1 to fc2 in FIG. 10. In the range where frequencies of relative longitudinal speeds ΔVi are smaller than fc1 in FIG. 10, the damping effect of longitudinal vibrations of wheels by controlling braking-driving forces of the wheels is substantially 0. In the range where frequencies of relative longitudinal speeds ΔVi are larger than fc2 in FIG. 10, controlling braking-driving forces of the wheels executed in accordance with the present disclosure might worsen longitudinal vibrations of wheels.

As is understood form the explanation given above referring to FIG. 10, in the range where frequencies of relative longitudinal speeds ΔVi are low, damping effect cannot be expected by correcting first target braking-driving torques Tt1i with second target braking-driving torques Tt2i. In contrast, in the range where frequencies of relative longitudinal speeds ΔVi are high, if first target braking-driving torques Tt1i are corrected with second target braking-driving torques Tt2i, longitudinal vibrations of the vehicle body 18 are caused to worsen. Accordingly, in a situation where frequencies of relative longitudinal speeds ΔVi are not within the specific frequency range, it is preferable to reduce second target braking-driving torques Tt2i in magnitude when first target braking-driving torques Tt1i are corrected with second target braking-driving torques Tt2i.

According to the third embodiment, in step 60, relative longitudinal speeds ΔVi of the wheels are frequency analyzed to derive principal frequencies fm of relative longitudinal speeds ΔVi and coefficient Cv is calculated by referring to a map shown in FIG. 7 based on each of principal frequencies fm. Accordingly, when principal frequencies fm are within the specific frequency range, second target braking-driving torques Tt2i can be increased in magnitude, which enables to achieve effective damping. In contrast, when principal frequencies fm are not within the specific frequency range, second target braking-driving torques Tt2i can be decreased in magnitude, which enables reduction of the amount of unnecessary correction of braking-driving torques.

In a general electric vehicle, harshness becomes perceptible when vehicle speed is 40 km/h or in the vicinity. According to the above-described embodiments, in step 50, reference value ΔV0 is variably set in accordance with vehicle speed V so that it assumes a small value when vehicle speed V is 40 km/h or in the vicinity. As such, since in step 70, an affirmative decision is easily made when vehicle speed V is 40 km/h or in the vicinity, second target braking-driving torques Tt2i can be decreased in magnitude, which enables enhancement in longitudinal compliance of the suspensions. Consequently, as compared to where reference value ΔV0 is constant irrespective of vehicle speed V, harshness can be improved.

### Modified Embodiment

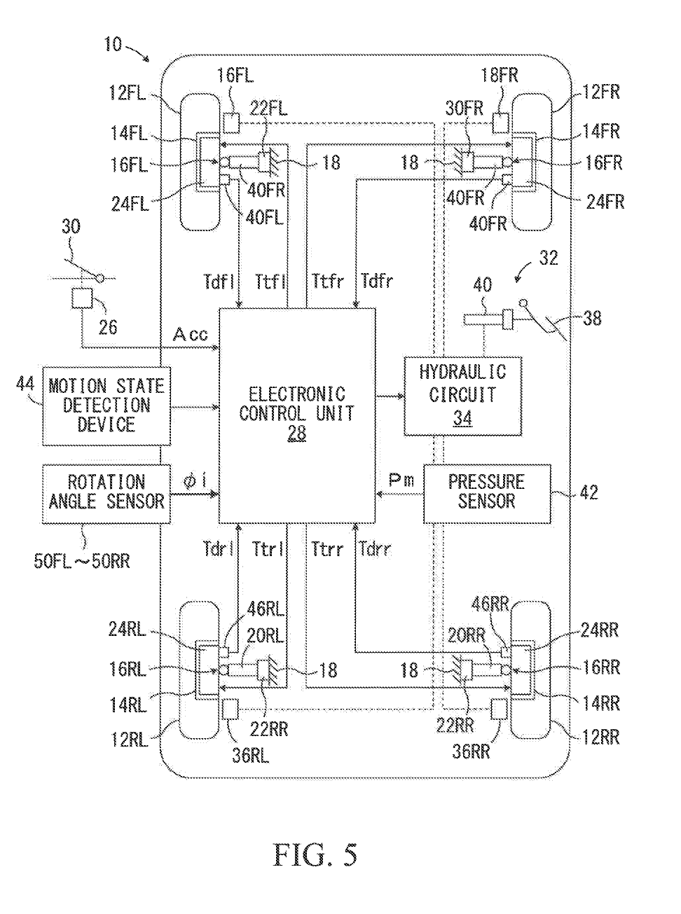

FIG. 5 is a schematic view for illustrating an electric vehicle 10 according to a modified embodiment of the present disclosure applied to a four-wheel drive vehicle of in-wheel motor type. Note that, in FIG. 5, the same parts as those illustrated in FIG. 1 are denoted by the same reference numerals as those of FIG. 1.

In the modified embodiment, the vehicle 10 does not have longitudinal acceleration sensors 48FL-48RR which are installed in the above-mentioned embodiments. The electronic control unit 28 calculates longitudinal speeds Vbi (i=fl, fr, rl and rr) of the vehicle body at positions corresponding to the wheels 12FL-12RR based on vehicle speed V and yaw rate of the vehicle 10 about its gravity center which are detected by the motion state detection device 44, longitudinal distances from the gravity center of the vehicle 10 to axels of wheels and a tread of the vehicle 10. Consequently, the motion state detection device 44 and the electronic control unit 28 cooperate with each other to function as a device for detecting longitudinal speeds of the vehicle body at positions corresponding to the wheels. Note that longitudinal speeds may be calculated as integrated values of longitudinal accelerations of the vehicle body at positions corresponding to the wheels 12FL-12RR.

The in-wheel motors 24FL-24RR have therein rotation angle sensors (resolvers) 50FL-50RR, respectively, which detect rotation angles φi (i=fl, fr, rl and rr) of the corresponding in-wheel motors. The electronic control unit 28 calculates longitudinal speeds Vwi (i=fl, fr, rl and rr) of the wheels 12FL-12RR on the basis of change rates of rotation angles φi. Thus, the rotation angle sensors 50FL-50RR and the electronic control unit 28 cooperate to function as a device for detecting longitudinal speeds of the wheels.

In general, a vehicle speed sensor and a yaw rate sensor are installed in a four-wheel drive vehicle of in-wheel motor type in which vehicle travelling behavior control is executed and in-wheel motors 24FL-24RR have therein rotation angle sensors. Consequently, according to the modified embodiment, braking-driving force control of the wheels for reducing longitudinal vibrations of vehicle body can be achieved by effectively utilizing sensors installed in a four-wheel drive vehicle of in-wheel motor type in which vehicle travelling behavior control is executed.

It is to be noted that a routine for controlling braking-driving forces of the wheels in the modified embodiment may be any of the control routines in the above-described embodiments. Thus, in the modified embodiment, as in the above-described embodiments, it is possible to reduce transmission of excitation forces from the wheels 12FL-12RR to the vehicle body 18 to attenuate longitudinal vibrations of vehicle body 18.

The specific embodiments of the present disclosure are described in detail above. However, the present application is not limited to the above-mentioned embodiments. It is apparent for those skilled in the art that various other embodiments may be employed within the scope of the present disclosure.

For example, in the above-mentioned respective embodiments and the modified embodiment, in step 70, a decision is made as to whether or not absolute values of relative longitudinal speeds ΔVi are larger than the reference value ΔV0, and when an affirmative decision is made, in step 80, second target braking-driving torques Tt2i are calculated in accordance with the above-mentioned Formula (11). However, steps 70 and 80 may be omitted.

In the above-mentioned respective embodiments and the modified embodiment, in step 50, a reference value ΔV0 is calculated by referring to a map shown in FIG. 6 based on vehicle speed V to variably set a reference value ΔV0 in accordance with vehicle speed V. However, a reference value ΔV0 may be a constant positive value irrespective of vehicle speed V.

For example, in the above-mentioned respective embodiments and the modified embodiment, the in-wheel motors 24FL-24RR are adapted to impart driving forces independently from each other to the wheels 12FL-12RR, respectively. Aspects of the present disclosure, however, may be applied to a vehicle which has two front wheels or two rear wheels that are driven wheels or driven by drive means other than in-wheel motors.

While in the above-mentioned respective embodiments, driving electric motors for imparting driving forces to the wheels 12FL-12RR are the in-wheel motors 24FL-24RR, they may be installed on suspension arms or on-board motors installed on the vehicle body.

Further, the above-mentioned respective embodiments and the modified embodiment may be implemented in any combination. In that case, the same benefits of the embodiments combined can be attained.

What is claimed is:

1. An electric vehicle comprising:
driving wheels suspended from a vehicle body by suspensions configured to resiliently allow the driving wheels to displace longitudinally relative to the vehicle body,
electric motors configured to impart driving forces to the corresponding driving wheels independently from each other,
a brake device configured to impart braking forces to the driving wheels independently from each other,
a controller configured to calculate, for at least one wheel of the electric vehicle, final target braking-driving forces of the driving wheels, and control, for the at least one wheel, an electric motor of the electric motors or the brake device so that braking-driving forces of the driving wheels conform to the corresponding final target braking-driving forces,
wherein:
the controller is configured to, for the at least one wheel, calculate relative longitudinal speeds of the driving wheels which are relative to the vehicle body; calculate target correction amounts of the target braking-driving forces for reducing in magnitude longitudinal accelerations of the driving wheels relative to the vehicle body based on the relative longitudinal speeds; and correct the target braking-driving forces with the target correction amounts to calculate the final target braking-driving forces of the driving wheels.

2. The electric vehicle according to claim 1, wherein:
the controller is configured to limit the target correction amounts in magnitude by limiting the magnitudes of the relative longitudinal speeds to a reference value when the magnitudes of the relative longitudinal speeds are larger than the reference value.

3. The electric vehicle according to claim 1, wherein:
the controller is configured to process the relative longitudinal speeds by a low-pass filter and to calculate the target correction amounts based on the low-pass filtered relative longitudinal speeds.

4. The electric vehicle according to claim 1, wherein:
the controller is configured to frequency analyze the relative longitudinal speeds and limit the target correction amounts in magnitude when principal frequencies of the relative longitudinal speeds are not within a predetermined frequency range.

5. The electric vehicle according to claim 1, wherein:
the electric vehicle comprises motion state detection devices configured to detect longitudinal accelerations of the vehicle body at positions corresponding to the driving wheels and longitudinal acceleration sensors configured to configured to detect longitudinal accelerations of the driving wheels; and
the controller is configured to calculate the relative longitudinal speeds by integrating differences between the longitudinal accelerations of the vehicle body and the longitudinal accelerations of the driving wheels.

6. The electric vehicle according to claim 1, wherein:
the electric vehicle comprises devices configured to detect longitudinal speeds of the vehicle body at positions corresponding to the driving wheels and devices configured to detect longitudinal speeds of the driving wheels; and
the controller is configured to calculate the relative longitudinal speeds by calculating differences between the longitudinal speeds of the vehicle body and the longitudinal speeds of the driving wheels.

7. The electric vehicle according to claim 2, wherein:
the controller is configured to process the relative longitudinal speeds by a low-pass filter and to calculate the target correction amounts based on the low-pass filtered relative longitudinal speeds.

8. The electric vehicle according to claim 2, wherein:
the controller is configured to frequency analyze the relative longitudinal speeds and limit the target correction amounts in magnitude when principal frequencies of the relative longitudinal speeds are not within a preset specific frequency range.

9. The electric vehicle according to claim 2, wherein:
the reference value is calculated by referring to a map dependent on vehicle speed.

10. The electric vehicle according to claim 9 wherein:
the map is based on characteristics of the electric vehicle.

11. The electric vehicle according to claim 9, wherein:
the reference value comprises a first value when the vehicle speed is less than a lower limit speed, and a second value when the vehicle speed is greater than the lower limit speed.

12. The electric vehicle according to claim 11, wherein:
the lower limit speed is 40 kilometers per hour.

13. The electric vehicle according to claim 11, wherein:
the reference value comprises a third value when the vehicle speed is greater than an upper limit speed.

14. The electric vehicle according to claim 1, wherein:
the controller is configured to calculate longitudinal speeds of the vehicle body at positions corresponding to the driving wheels and calculate longitudinal speeds of the driving wheels; and
the controller is configured to calculate the relative longitudinal speeds by calculating differences between the longitudinal speeds of the vehicle body and the longitudinal speeds of the driving wheels.

15. A suspension control device for an electric vehicle comprising driving wheels suspended from a vehicle body by suspensions configured to resiliently allow the driving wheels to displace longitudinally relative to the vehicle body, electric motors configured to impart driving forces to the corresponding driving wheels independently from each other, and a brake device configured to impart braking forces to the driving wheels independently from each other, the device comprising:
a processor; and
a computer-readable medium storing instructions that, when executed by the processor, cause the processor to, for at least one wheel of the electric vehicle:
calculate relative longitudinal speeds of the driving wheels which are relative to the vehicle body;
calculate target correction amounts of target braking-driving forces for reducing in magnitude longitudinal accelerations of the driving wheels relative to the vehicle body based on the relative longitudinal speeds;
correct the target braking-driving forces with the target correction amounts to calculate final target braking-driving forces of the driving wheels; and
control an electric motor of the electric motors or the brake device so that braking-driving forces of the driving wheels conform to the corresponding final target braking-driving forces.

16. The device according to claim 15, wherein:
the processor is configured to limit the target correction amounts in magnitude by limiting the magnitudes of the relative longitudinal speeds to a reference value when the magnitudes of the relative longitudinal speeds are larger than the reference value.

17. The device according to claim 16, wherein:
the reference value is calculated by referring to a map dependent on vehicle speed.

18. The device according to claim 15, wherein:
the processor is configured to calculate longitudinal speeds of the vehicle body at positions corresponding to the driving wheels and calculate longitudinal speeds of the driving wheels; and
the processor is configured to calculate the relative longitudinal speeds by calculating differences between the longitudinal speeds of the vehicle body and the longitudinal speeds of the driving wheels.

19. The device according to claim 15, wherein:
the processor is configured to process the relative longitudinal speeds by a low-pass filter and to calculate the target correction amounts based on the low-pass filtered relative longitudinal speeds.

20. The device according to claim 15, wherein:
the processor is configured to frequency analyze the relative longitudinal speeds and limit the target correction amounts in magnitude when principal frequencies of the relative longitudinal speeds are not within a predetermined frequency range.
